(19) United States
(12) Patent Application Publication
(10) Pub. No.: US 2025/0034741 A1
(43) Pub. Date: Jan. 30, 2025

(54) COMPOSITE MATERIAL, METHOD FOR PRODUCING THE COMPOSITE MATERIAL, AND TERMINAL

(71) Applicant: DOWA METALTECH CO., LTD., Tokyo (JP)

(72) Inventors: Hirotaka TAKAHASHI, Tokyo (JP); Takao TOMIYA, Tokyo (JP); Tatsuhiro DOI, Tokyo (JP); Hirotaka KOTANI, Tokyo (JP); Yukiya KATO, Tokyo (JP); Hiroto NARIEDA, Tokyo (JP)

(73) Assignee: DOWA METALTECH CO., LTD., Tokyo (JP)

(21) Appl. No.: 18/715,917

(22) PCT Filed: Dec. 9, 2022
(86) PCT No.: PCT/JP2022/045452

§ 371 Date: Jun. 3, 2024

(30) Foreign Application Priority Data
Dec. 21, 2021 (JP) 2021-207514

(51) Int. Cl. C25D 3/46; C25D 5/50; C25D 15/00

(52) U.S. Cl. CPC C25D 3/46; C25D 5/50; C25D 15/00

(57) ABSTRACT

There is provided a composite material having a composite film on a substrate, the composite film including a silver layer that contains carbon particles, wherein a crystallite size of silver of the composite film is 30 to 100 nm and Vickers hardness Hv of the composite film is 75 or more.

### TECHNICAL FIELD

The present invention relates to a composite material in which a predetermined composite film is formed on a substrate, a method for producing the same, etc., and particularly, relates to a composite material used as a material for a contact part such as a switch and a connector where sliding occurs, and a method for producing the same.

### DESCRIPTION OF RELATED ART

Conventionally, a silver (Ag) plated material with silver plating applied to a conductive material is used as a material for an electrical contact part such as a switch and a connector where sliding occurs, to prevent oxidation of the conductive material such as copper (Cu) and copper alloy due to heating during a sliding process.

However, the silver plated material is soft and easily worn, and generally has a high coefficient of friction, thus involving a problem that it easily peels off due to sliding. In order to solve this problem, there is a method of improving wear resistance by providing a composite material with a film formed on a conductive material by electrical plating, the film being a composite film in which graphite particles of carbon particles such as graphite and carbon black that have excellent heat resistance, abrasion resistance and lubricity, are dispersed in a silver matrix (for example, see Patent documents 1 and 2).

### PRIOR ART DOCUMENT

### Patent Documents

[Patent Document 1] Japanese Patent Application Publication No. 2011-74499
[Patent Document 2] Japanese Patent Application Publication No. 2020-117747

### SUMMARY OF THE INVENTION

### Problem to be Solved by the Invention

However, though a silver-plated material in which a silver-plated layer with graphite particles dispersed in a silver matrix is formed on a substrate, as disclosed in Patent documents 1 and 2, has superior wear resistance compared to a silver-plated material in which a silver-plated layer not containing graphite particles is formed on a substrate, the silver-plated material of Patent documents 1 and 2 may still be insufficient for practical use.

In view of such a conventional problem, the present inventor conducted extensive research on a composite material having excellent wear resistance, that is, a composite material in which a composite film containing carbon particles in a silver layer is formed on a substrate. As a result, it is found that the above-described conventional problem can be solved by performing electroplating using a silver plating solution containing a specific component.

On the other hand, during this intensive study, the following new problem was found. The finding is as follows: although it is true that the above conventional problem can be solved based on the above finding, the composite material based on the above finding needs to be improved in bending workability while being excellent in wear resistance. Regarding the bending workability, cracks may occur inside the composite film of the composite material during bending, resulting in a state in which part or all of the composite film is likely to fall off from the composite material. In this specification, the fact that such a state is difficult to occur is expressed as “excellent bending workability.”

Accordingly, an object of the present invention is to provide a composite material in which a composite film containing carbon particles in a silver layer is formed on a substrate, and which has excellent wear resistance and bending workability.

### Means for Solving the Problem

[1] A composite material having a composite film on a substrate, the composite film including a silver layer that contains carbon particles, wherein a crystallite size of silver of the composite film is 30 to 100 nm and Vickers hardness Hv of the composite film is 75 or more.
[2] The composite material according to [1], wherein a proportion of the carbon particles in a surface of the composite film is 1 to 80% by area.
[3] The composite material according to [1] or [2], wherein the composite film has a thickness of 0.5 to 45 μm.
[4] The composite material according to any one of [1] to [3], wherein the composite film has a carbon content of 1 to 50% by mass.
[5] The composite material according to any one of [1] to [4], wherein the substrate is composed of Cu or a Cu alloy.
[6] A method for producing a composite material, the method including: performing
electroplating in a silver plating solution containing carbon particles to form a composite film on a substrate, the composite film including a silver layer that contains carbon particles; then,
applying heat treatment to the composite film,
wherein the silver plating solution contains a compound A represented by the following general formula (I), and
after forming the composite film on the substrate, the heat treatment is applied to the composite film to increase a crystallite size of silver of the composite film.

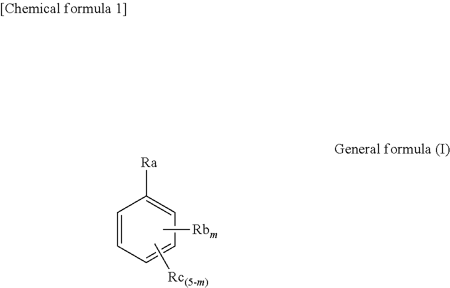

(In formula (I), m is an integer from 1 to 5,
Ra is a carboxyl group,
Rb is an aldehyde group, carboxyl group, amino group, hydroxyl group or sulfonic acid group,
Rc is hydrogen or is an arbitrary substituent,
when m is 2 or more, multiple Rb's may be the same or different from each other,
when m is 3 or less, multiple Rc's may be the same or different from each other, and
Ra and Rb may each be independently bonded to a benzene ring through a divalent group composed of at least one selected from a group consisting of —O— and —CH₂—).
   [7] The method for producing a composite material according to [6], wherein 80≤T≤750, 3≤t≤86400, 240≤Y≤1000 are established, in which heating temperature during the heat treatment is T (° C.), heating time during the heat treatment is t (seconds), and Y=T×log₁₀(t).
   [8] The method for producing a composite material according to [6] or [7], wherein the silver plating solution does not substantially contain a cyanide compound.
   [9] The method for producing a composite material according to any one of [6] to [8], wherein the silver plating solution contains a compound having a sulfonic acid group.
   [10] The method for producing a composite material according to any one of [6] to [9], wherein the substrate is composed of copper (Cu) or a Cu alloy.
   [11] The method for producing a composite material according to any one of [6] to [10], wherein the carbon particles are graphite particles whose volume-based cumulative 50% particle diameter (D50) is 0.5 to 15 μm as measured by a laser diffraction/scattering particle size distribution analyzer.
   [12] A terminal in which the composite material according to any one of [1] to [5] is used as its constituent material.

### Advantage of the Invention

According to the present invention, there is provided a composite material in which a composite film containing carbon particles in a silver layer is formed on a substrate, and having excellent wear resistance and bending workability, and a method for producing the same.

### DETAILED DESCRIPTION OF THE INVENTION

Embodiments of the present invention will be described below.

### [Method for Producing a Composite Material]

In an embodiment of the method for producing a composite material of the present invention, electroplating is performed in a specific silver plating solution containing carbon particles, to form a composite film on a substrate, the composite film containing carbon particles in the silver layer, and then heat treatment is performed. Each configuration of this method for producing a composite material will be described below.

### <<Substrate>>

A constituent material of the substrate on which the composite film is formed is preferably one that can be silver plated and has electrical conductivity required for a material such as a contact part like a switch and a connector where sliding occurs, and further, from a viewpoint of a cost, Cu (copper) and Cu alloys are preferable as constituent materials. As the Cu alloy, it is preferable to use an alloy composed of Cu and at least one selected from a group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum), Ti (titanium), and unavoidable impurities, from a viewpoint of achieving both electrical conductivity and wear resistance. An amount of Cu in the Cu alloy is preferably 85% by mass or more, more preferably 92% by mass or more (the amount of Cu is preferably 99.95% by mass or less).

As described below, the substrate is preferably used for a terminal purpose (as a composite material in which a composite film is formed), and the substrate itself may be formed into a desired shape depending on its use, or the substrate may have a flat shape (such as a flat plate shape), and after being made into a composite material, the material may be formed into a desired shape.

### <<Formation of a Base Layer>>

In the method for producing a composite material of the present invention, a base layer may be formed on the substrate, and electroplating, which will be described later, may be applied to the base layer. The base layer is formed for the purpose of preventing copper in the substrate from diffusing and oxidizing on a plating surface and deteriorating the heat resistance of the composite material, and for the purpose of improving the adhesion of the composite film. Constituent metals of the base layer include Cu, Ni, Sn, and Ag. The base layer may be a layer composed of each of Cu, Ni, Sn, and Ag, or a layer combining them (in a laminated structure), and the base layer may be formed on an entire surface layer of the substrate or on a part thereof, depending on the use of the composite material to be produced.

The method for forming the base layer is not particularly limited, and it can be formed by electroplating by a known method using a plating solution containing ions of the constituent metals described above. The plating solution preferably does not substantially contain a cyanide compound from a viewpoint of a cost incurred in wastewater treatment.

### <<Ag Strike Plating>>

Before forming the composite film on the substrate, it is preferable to form a very thin intermediate layer by Ag strike plating to improve the adhesion between the substrate and the composite film. When forming the base layer on the substrate, Ag strike plating is performed on the base layer. As a method for performing Ag strike plating, any conventionally known method can be employed without particular limitation as long as the effect of the present invention is not impaired. The plating solution used for Ag strike plating preferably does not substantially contain a cyanide compound from the viewpoint of a cost incurred in a wastewater treatment.

### <<Electroplating>>

In the method for producing a composite material of the present invention, a composite film is formed on a substrate, the composite film including a silver layer that contains carbon particles, by electroplating the substrate described above in a specific silver plating solution.

### <Silver Plating Solution>

The silver plating solution contains silver ions, specific compound A, and carbon particles, and preferably has an Sb (antimony) content (concentration) of 1 g/L or less.

### (Silver Ion)

Silver plating solution contains silver ions. The concentration of silver in this silver plating solution is preferably 5 to 150 g/L, more preferably 10 to 120 g/L, and most preferably 20 to 100 g/L, from a viewpoint of a formation speed of the composite film and a suppression of appearance unevenness of the composite film.

### (Compound A)

Next, compound A is represented by the following general formula (I).

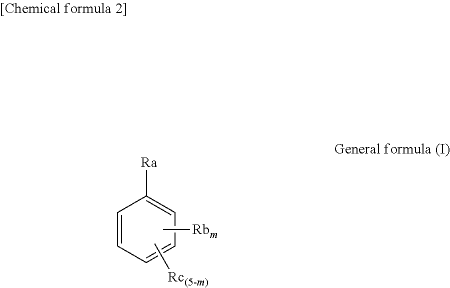

In formula (I), m is an integer of 1 to 5, Ra is a carboxyl group, Rb is an aldehyde group, carboxyl group, amino group, hydroxyl group or sulfonic acid group, Rc is hydrogen or is an arbitrary substituent, and Ra and Rb may each be independently bonded to a benzene ring through a divalent group composed of at least one selected from a group consisting of —O— and —CH₂—. Examples of the divalent group include —CH₂—CH₂—O—, —CH₂—CH₂—CH₂—O—, (—CH₂—CH₂—O—)ₙ (n is an integer of 2 or more)).

Compound A is considered to reduce a crystallite size of silver in the composite film formed by electroplating, due to adsorbing on the surface of deposited silver and suppressing the growth of silver crystals. Thus, the composite material with excellent hardness and therefore excellent wear resistance can be obtained without using Sb.

Further, in the above general formula (I), when m is 2 or more, multiple Rb's may be the same or different from each other, and when m is 3 or less, multiple Rc's may be the same or different from each other. Regarding Rc, examples of the “arbitrary substituent” include an alkyl group having 1 to 10 carbon atoms, an alkylaryl group, an acetyl group, a nitro group, a halogen group, and an alkoxyl group having 1 to 10 carbon atoms.

The concentration of compound A in the silver plating solution is preferably 2 to 250 g/L, more preferably 3 to 200 g/L, from a viewpoint of suppressing appearance unevenness of the composite film and appropriately controlling the crystallite size of silver in the composite film to be formed.

Even in the case of a compound other than compound A, it is acceptable to use a compound that can appropriately reduce the crystallite size of silver in the composite film which is formed by electroplating, by adsorbing on the surface of deposited silver and suppressing the growth of silver crystals, that is, a crystallite size growth suppressing compound.

### (Carbon Particles)

Next, the silver plating solution contains carbon particles. When the silver plating solution contains carbon particles, the carbon particles will become entangled in a silver matrix when the composite film (silver plated film) is formed on the substrate by electroplating. When the composite film contains carbon particles, the wear resistance of the composite material increases. From a viewpoint of exhibiting such a function, the carbon particles are preferably graphite particles. A volume-based cumulative 50% particle diameter (D50) of the carbon particles measured by a laser diffraction/scattering particle size distribution analyzer is preferably 0.5 to 15 μm, more preferably 1 to 10 μm from a viewpoint of ease of being entangled into a silver plated film. Further, the shape of the carbon particles is not particularly limited, and may be approximately spherical, scale-shaped, irregular, etc., but a scale-shape is preferable because the wear resistance of the composite material can be improved due to smooth surface of the composite film.

Further, it is preferable to oxidize the carbon particles to remove lipophilic organic substances adsorbed on the surfaces of the carbon particles. Such lipophilic organic substances include aliphatic hydrocarbons such as alkanes and alkenes, and aromatic hydrocarbons such as alkylbenzenes. In addition to wet oxidation treatment, dry oxidation treatment using O₂ gas etc., can be used as the oxidation treatment applied to the carbon particles. However, it is preferable to use wet oxidation treatment from a viewpoint of mass productivity, and carbon particles having a large surface area can be uniformly treated by the wet oxidation treatment. As a method of the wet oxidation treatment, there is a method of suspending carbon particles in water and then adding an appropriate amount of oxidizing agent. As the oxidizing agent, oxidizing agents such as nitric acid, hydrogen peroxide, potassium permanganate, potassium persulfate, and sodium perchlorate can be used. It is considered that the lipophilic organic substance attached to carbon particles is oxidized by the added oxidizing agent, becomes easily soluble in water, and is appropriately removed from the surfaces of the carbon particles. Further, after performing this wet oxidation treatment, filtration is performed, and the carbon particles are further cleaned with water, thereby further enhancing the effect of removing lipophilic organic substances from the surfaces of carbon particles. By oxidizing carbon particles, lipophilic organic substances such as aliphatic hydrocarbons and aromatic hydrocarbons can be removed from the surfaces of carbon particles. Therefore, according to analysis using 300° C. heated gas, the gas generated by heating carbon particles at 300° C. after oxidation treatment, hardly contains lipophilic aliphatic hydrocarbons such as alkanes and alkenes, and lipophilic aromatic hydrocarbons such as alkylbenzenes. Even when some aliphatic hydrocarbons and aromatic hydrocarbons are contained in the carbon particles after oxidation treatment, carbon particles can be uniformly dispersed in the silver plating solution used in the present invention, but preferably the carbon particles do not contain hydrocarbons with a molecular weight of 160 or more, and preferably gas intensity (purge and trap gas chromatography mass spectrometry intensity) of the hydrocarbons with a molecular weight of less than 160 in the carbon particles is 5,000,000 or less when heated at 300° C.

Further, an amount of carbon particles in the silver plating solution is preferably 10 to 100 g/L, more preferably 15 to 90 g/L, and most preferably 20 to 70 g/L, from a viewpoint of the wear resistance of the composite material obtained by forming the composite film on the substrate using a silver plating solution, and because there is a limit to the amount of carbon particles that can be introduced into the composite film.

### (Sb (Antimony))

The silver plating solution used in the present invention preferably does not substantially contain Sb, and specifically, Sb content in the silver plating solution is 1 g/L or less, preferably 0.5 g/L or less, more preferably 0.1 g/L or less, and even more preferably 0.05 g/L or less.

### (Complexing Agent)

The silver plating solution used in the present invention preferably contains a complexing agent. The complexing agent complexes the silver ions in the silver plating solution to increase its stability as an ion. This action increases the solubility of silver in the solvent constituting the plating solution.

A wide variety of complexing agents having the above-described functions can be used, but a compound having a sulfonic acid group is preferable from a viewpoint of stability of the complex to be formed. Examples of the compound having the sulfonic acid group include alkylsulfonic acids having 1 to 12 carbon atoms, alkanolsulfonic acids having 1 to 12 carbon atoms, and hydroxyarylsulfonic acids. Specific examples of these compounds include methanesulfonic acid, 2-propanolsulfonic acid and phenolsulfonic acid.

An amount of the complexing agent in the silver plating solution is preferably 30 to 200 g/L, more preferably 50 to 120 g/L, from a viewpoint of stabilizing silver ions.

### (Other Additives)

As other additives, for example, the silver plating solution used in the present invention may contain a brightening agent, a hardening agent, and a conductivity salt. Examples of the hardening agent include carbon sulfide compounds (e.g. carbon disulfide), inorganic sulfur compounds (e.g. sodium thiosulfate), organic compounds (sulfonates), selenium compounds, tellurium compounds, metals from group 4B or 5B in a periodic table (excluding antimony), etc. Examples of the conductivity salt include potassium hydroxide.

### (Solvent)

The solvent constituting the silver plating solution is mainly water. Water is preferable because of its solubility of (complexed) silver ions, solubility of other components contained in the plating solution, and low environmental impact. Further, a mixed solvent of water and alcohol may be used as the solvent.

### (Cyanide Compound)

The main components of the silver plating solution used in the present invention are as described above, and this silver plating solution typically contains substantially no cyanide (specifically, content of the cyanide compound in the silver plating solution is 1 mg/L or less.). The cyanide compound is a compound containing a cyano group (—CN), and the cyanide compound can be quantified according to JIS K0102:2019. The cyanide compound is a substance subject to Water Pollution Control Act (effluent standards) and PRTR (Environmental Pollutant Release and Transfer Registration) system. Therefore, the cost incurred in wastewater treatment is high. As described above, the silver plating solution used in the present invention typically contains substantially no cyanide, so its cost incurred in wastewater treatment is low.

### <Conditions for Electroplating>

Next, conditions for electroplating using the silver plating solution described above will be explained. For example, by electroplating as described below, metallic silver is deposited on the substrate, and at the same time carbon particles are entangled in the silver matrix, thereby forming a composite film. Further, due to the function of compound A, the crystallite size of silver in the composite film is kept small (specifically, for example, about 2 to 30 nm). Further, preferably, the silver plating solution does not substantially contain Sb (the content is 1 g/L or less), so the formed composite film also preferably does not substantially contain Sb (the content is 1% by mass or less). Sb possibly deteriorates the heat resistance of the composite material. From the above reason, the composite material obtained by the embodiment of the method for producing a composite material of the present invention has excellent wear resistance (and preferably also heat resistance).

### (Cathode and Anode)

The substrate to be electroplated is a cathode. For example, a silver electrode plate that dissolves to provide silver ions is an anode.

### (Current Density)

The cathode and the anode are immersed in the silver plating solution (plating bath), and a current is applied to plate them with silver. A current density here is preferably 0.5 to 10 A/dm², more preferably 1 to 8 A/dm², and even more preferably 1.5 to 6 A/dm² from a viewpoint of a formation rate of the composite film and a suppression of uneven appearance of the composite film.

### (Temperature, Stirring, Plating Time, Part to be Plated)

The temperature (plating temperature) of the plating bath (silver plating solution) during electroplating, is preferably 15 to 50° C., more preferably 20 to 45° C., from a viewpoint of plating production efficiency and preventing excessive evaporation of liquid. At this time, the plating bath is stirred preferably at 200 to 550 rpm, more preferably at 350 to 500 rpm, from a viewpoint of uniform plating. The silver plating time (current application time) can be adjusted as appropriate depending on a desired thickness of the composite film, but is typically in a range of 25 to 1800 seconds. Further, a target part to be plated may be an entire surface layer of the substrate or a part of the surface layer of the substrate depending on the use of the composite material to be produced.

### <<Partial Removal Treatment of Carbon Particles on the Surface of the Composite Film>>

By the electroplating described above, the composite film is formed on the substrate. On the surface of this composite film, there are carbon particles that are entangled (buried) in the silver matrix and difficult to fall off, and carbon particles that are attached to the surface rather than entangled and easily fall off. The latter possibly contaminates equipment during bending of the composite material. Therefore, it is preferable to remove such carbon particles by cleaning. One of the cleaning methods is ultrasonic cleaning for cleaning the surface of the composite film. The ultrasonic cleaning is preferably performed at 20 to 100 kHz for 1 to 300 seconds. Another cleaning method includes electrolytic cleaning treatment. In this case, electrolytic cleaning is preferably performed at 1 to 30 A/dm² for 10 to 300 seconds.

### <<Heat Treatment>>

The composite film is formed on the substrate by the electroplating described above, and some of the carbon particles on the surface of the composite film are cleaned and removed as necessary, and then, in the method for producing a composite material of the present invention, heat treatment is applied to the composite film to increase the crystallite size of silver in the composite film. It is supposed that in the composite film formed by electroplating, high strain energy exists within the silver crystals, and the heat treatment applied to this composite film causes release of the strain energy and increases crystallite size. The reduction in the strain energy suppresses the occurrence of cracks within the composite film when the composite material is subjected to bending. As a result, it is considered that the composite material of the present invention can achieve both wear resistance and bending workability.

This heat treatment is not specifically limited as long as it can increase the crystallite size of silver in the composite film already produced on the substrate. As a device, known devices such as a constant temperature oven, drying oven, heating oven (reflow oven), etc., may be used. An ambient air is not limited either, and may be an atmospheric state or a non-atmospheric state. The heat treatment conditions are, for example, an ambient temperature of 80 to 750° C. and a time of 10 seconds to 24 hours (=86400 seconds). Further, when the heating temperature is T (° C.), the heating time is t (seconds) during the heat treatment, it is preferable to satisfy Y=T×log₁₀(t), 80≤T≤750, 3≤t≤86400, 240≤Y≤1000, more preferably to satisfy 80≤T≤670 and 260≤Y≤750. Regarding the influence on the crystallite size, formula T×log₁₀(t) was set in consideration of a larger influence of the temperature T than the heating time t. The crystallite size of silver in the composite film of the composite material obtained by performing such heat treatment, is moderately small, such as 30 to 100 nm, preferably 35 to 90 nm, more preferably 40 to 80 nm, even more preferably more than 40 nm and 80 nm or less, particularly preferably 42 to 78 nm.

### [Composite Material]

Embodiments of the composite material of the present invention will be described below. The composite material is a composite material in which a composite film containing carbon particles in a silver layer is formed on a substrate, that is, it is a composite material in which the Vickers hardness of the composite film and the crystallite size of silver in the composite film are within a predetermined range. Preferably, the Sb content in the composite film is 1% by mass or less. This composite material can be produced, for example, by the method for producing a composite material of the present invention. Each configuration of this composite material will be explained below.

### <Crystallite Size and Vickers Hardness>

The crystallite size of silver in the composite film according to an embodiment of the composite material of the present invention is appropriately small, such as 30 to 100 nm. Since the crystallite size is as small as 100 nm or less, the hardness of the composite film is high due to Hall-Petch relationship (generally, the smaller the crystal grains of a metal material, the stronger it is), and the high hardness makes the composite film difficult to scrape and increases the wear resistance of the composite material. Further, when the crystallite size becomes 30 nm or more through the heat treatment described above to increase the crystallite size, excellent bending workability is exhibited. From a viewpoint of making these effects more significant, the crystallite size is preferably from 35 to 90 nm, more preferably from 40 to 80 nm, even more preferably more than 40 nm and 80 nm or less, particularly preferably from 42 to 78 nm.

In the present invention, as the crystallite size of silver, in order to reduce bias due to crystal planes, a value obtained by averaging (adding and dividing by 2) the crystallite sizes of (111) plane and (222) plane of silver is adopted. A more detailed method for measuring the crystallite size will be explained in Examples.

The above bending workability was evaluated by the method described in <Evaluation of bending workability of the composite material> in Examples described later. Specifically, a reduction rate of the thickness of the composite film at a vertex of an indented specimen made from the composite material of the present invention before and after applying and peeling off the adhesive tape (adhesive force: 4.02N/10 mm) (when the thickness of the composite film before applying the adhesive tape is X, and the thickness of the composite film after peeling off the adhesive tape is Y, the reduction rate=(X−Y)/X×100%) is preferably 10% or less, more preferably 6% or less, particularly preferably 3% or less.

The composite film constituting the composite material of the present invention has high hardness, specifically, its Vickers hardness Hv is 75 or more, and the composite material of the present invention has excellent wear resistance. The Vickers hardness Hv is preferably 80 or more. Further, since there is a limit to the hardness that can be achieved, the Vickers hardness Hv is more preferably 90 to 210, particularly preferably 95 to 180. Details of the method for measuring the Vickers hardness Hv will be explained in Examples.

### <<Substrate>>

The substrate is the same as the substrate described above in the method of producing a composite material of the present invention. That is, Cu (copper) and Cu alloy are suitable as constituent elements in the substrate, and as the Cu alloy, it is preferable to use an alloy composed of Cu and at least one selected from a group consisting of Si (silicon), Fe (iron), Mg (magnesium), P (phosphorus), Ni (nickel), Sn (tin), Co (cobalt), Zn (zinc), Be (beryllium), Pb (lead), Te (tellurium), Ag (silver), Zr (zirconium), Cr (chromium), Al (aluminum), Ti (titanium), and unavoidable impurities, from a viewpoint of achieving both electrical conductivity and wear resistance.

### <<Composite Film>>

The composite film formed on the substrate includes a silver layer that contains carbon particles. In this silver layer, carbon particles are dispersed (preferably substantially uniformly) in a matrix composed of silver. When Ag strike plating is performed before forming the composite film, an intermediate layer formed by this strike plating exists between the substrate (or the base layer described later) and the composite film, but it is often so thin that it cannot be distinguished from the composite film. Further, the composite film may be formed on an entire surface layer of the substrate, or may be formed on a part of the surface layer.

### <Carbon Particles>

In the method for producing a composite material of the present invention, the carbon particles are similar to the carbon particles described above. That is, the carbon particles are preferably graphite particles, and the shape is not particularly limited, such as approximately spherical, scale-shaped, irregular, etc., but the scale-shape is preferable because the wear resistance of the composite material can be improved due to smooth surface of the composite film.

Further, an average primary particle size of the carbon particles is preferably 0.5 to 15 μm, more preferably 1 to 10 μm, from a viewpoint of the wear resistance of the composite material. The average primary particle size is an average value of long diameters of particles, and the long diameter is a length of a longest line segment that can be drawn within a particle in an image (plane) of the carbon particles in the composite film of the composite material, observed at an appropriate observation magnification. The long diameter is obtained for 50 or more particles.

### <Antimony (Sb)>

Preferably, the composite film does not substantially contain Sb, specifically, the Sb content in the composite film is 1% by mass or less, and from a viewpoint of heat resistance of the composite material, the Sb content is preferably 0.5% by mass or less, more preferably 0.1% by mass or less, and even more preferably 500 ppm or less. Details of the method for measuring the Sb content in the composite film will be explained in Examples.

### <Carbon Content and Area Ratio>

The composite film according to an embodiment of the composite material of the present invention contains carbon particles as described above, and the carbon content in the composite film is preferably 1 to 50% by mass, more preferably 1.5 to 40% by mass, and even more preferably 2 to 35% by mass, from a viewpoint of wear resistance and conductivity of the composite material. Details of the method for measuring the carbon content in the composite film will be explained in Examples.

Further, the ratio (area ratio) occupied by carbon particles on the surface of the composite film containing carbon particles is an indicator of wear resistance, and from a viewpoint of a balance between wear resistance and conductivity, it is preferably 1 to 80 area %, more preferably 1.5 to 80 area %, and still more preferably 2 to 80 area %. Details of the method for measuring the area ratio will be explained in Examples.

### ≤Total Content of Silver and Carbon>

An elemental composition of the composite film according to an embodiment of the composite material of the present invention typically includes essentially silver and carbon. Specifically, a total content of these elements in the composite film is 99% by mass or more, more preferably 99.5% by mass or more.

### ≤Thickness of the Composite Film>

The thickness of the composite film is not particularly limited, but from a viewpoint of wear resistance and conductivity, it is preferable that the composite film has a minimum thickness. When the thickness is too large, the effect of the composite film will be saturated and a raw material cost will increase. From this viewpoint, the thickness of the composite film is preferably 0.5 to 45 μm, more preferably 0.5 to 35 μm, and even more preferably 1 to 30 μm. Details of the method for measuring the thickness of the composite film will be explained in Examples.

### <<Base Layer>>

A base layer may be formed between the substrate and the composite film for various purposes. Constituent metals of the base layer include Cu, Ni, Sn, and Ag. For example, for the purpose of preventing copper in the substrate from diffusing onto the surface of the composite film and deteriorating heat resistance, it is preferable to form the base layer composed of Ni. When the substrate is a copper alloy containing zinc such as brass, and for the purpose of preventing the zinc in the substrate from diffusing onto the surface of the composite film, it is preferable to form the base layer composed of Cu. For the purpose of improving the adhesion of the composite film to the substrate, it is preferable to form the base layer composed of Ag. The thickness of the base layer is not particularly limited, but from a viewpoint of functionality and cost, it is preferably 0.1 to 2 μm, more preferably 0.2 to 1.5 μm. Further, Sn plated or reflow Sn plated material including Cu base and Ni base (laminated structure of Cu base, Ni base, and Sn base from a substrate side) are often used for the terminals of electrical and electronic components, and the base layer having such a laminated structure may also be formed in the present invention. Accordingly, in the present invention, the base of the composite film may be a layer composed of each of Cu, Ni, Sn, and Ag, or a layer combining them (in a laminated structure), or different layers may be formed depending on a location, such as forming the composite film defined by the present invention (the base layer may or may not be formed) on an electrical contact portion of the substrate and forming a reflow Sn plated base layer (the composite film is not formed) on a wire crimping portion.

### [Terminal]

Embodiments of the composite material of the present invention have excellent wear resistance and bending workability, and are therefore suitable as a constituent material of terminals (produced by bending) of especially electrical contact parts such as switches and connectors where sliding occurs during use.

### EXAMPLES

Examples of the composite material and the method for producing the same according to the present invention will be described in detail below. In this specification, a comparative example is not necessarily a conventional example.

### <Preparation of Carbon Particles>

80 g of scale-shaped graphite particles (PAG-3000 manufactured by Nippon Graphite Industries Co., Ltd.) having an average particle size of 4.8 μm were added as carbon particles to 1.4 L of pure water, and the temperature of this mixed solution was raised to 50° C. while stirring. The average particle size is a particle size with a volume-based cumulative value of 50%, as measured using a laser diffraction/scattering particle size distribution analyzer (MT3300 (LOW-WET MT300011 Mode) manufactured by Microtrac Bell Co., Ltd.). Next, after gradually dropping 0.6 L of a 0.1 mol/L potassium persulfate aqueous solution as an oxidizing agent into this mixed solution, oxidation treatment was performed by stirring for 2 hours, and thereafter, filtering and separating was performed using filter paper, and the obtained solid matter was washed with water.

When the carbon particles before and after this oxidation treatment were analyzed using a purge-and-trap gas chromatograph mass spectrometer (a device that is a combination of JHS-100 manufactured by Japan Analytical Industry Co., Ltd. as a thermal desorption device and GCMS QP-5050A manufactured by Shimadzu Corporation as a gas chromatograph mass spectrometer) to analyze the gas generated when heated at 300° C., it was found that the above oxidation treatment removed lipophilic aliphatic hydrocarbons (such as nonane, decane, 3-methyl-2-heptene, etc.) and lipophilic aromatic hydrocarbons (such as xylene) attached to the carbon particles.

### Example 1

### <Ag Strike Plating>

A plate material composed of Cu—Ni—Sn—P alloy with a thickness of 0.2 mm (copper alloy plate containing 1.0% by mass of Ni, 0.9% by mass of Sn, and 0.05% by mass of P, with a balance being Cu and unavoidable impurities) (NB109EH manufactured by DOWA Metaltech Co., Ltd.) was prepared. This plate material is used as a substrate, and using this substrate as a cathode and an iridium oxide mesh electrode plate (titanium mesh material coated with iridium oxide) as an anode, electroplating (silver strike plating) was performed at a current density of 5 A/dm² for 90 seconds in a sulfonic acid-based silver strike plating solution at 25° C., containing methanesulfonic acid as a complexing agent (Dyne Silver GPE-ST manufactured by Daiwa Kasei Co., Ltd., substantially free of cyanide compounds. Silver concentration: 3 g/L, methanesulfonic acid concentration: 42 g/L, antimony concentration: 0.05 g/L or less). The silver strike plating was performed on an entire surface layer of the substrate.

### <AgC Plating>

The above carbon particles (graphite particles) subjected to oxidation treatment were added to a sulfonic acid silver plating solution containing methanesulfonic acid as a complexing agent and having a silver concentration of 30 g/L and a methanesulfonic acid concentration of 60 g/L (Dyne Silver GPE-HB manufactured by Daiwa Kasei Co., Ltd. (containing compound A corresponding to general formula (I), with a solvent being mainly water)), to prepare a carbon particle-containing sulfonic acid silver plating solution containing carbon particles with a concentration of 50 g/L, silver with a concentration of 30 g/L, and methanesulfonic acid with a concentration of 60 g/L. This silver plating solution is substantially free of Sb and cyanide.

Next, using the above Ag strike plated substrate as a cathode and the silver electrode plate as an anode, electroplating was performed in the above carbon particle-containing sulfonic acid silver plating solution at a temperature of 25° C. and a current density of 3 A/dm² for 300 seconds while stirring at 400 rpm with a stirrer, to obtain a composite material in which a composite film (AgC plated film) containing carbon particles in a silver layer was formed on a substrate. The composite film was formed on an entire surface layer of the substrate.

Next, the AgC plated film was subjected to ultrasonic cleaning for 240 seconds at 28 kHz in pure water using an ultrasonic cleaner (USK-5 manufactured by As One Co., Ltd.) to remove part of the carbon on the surface, then washed with pure water, and dried with air blow.

Next, this composite film was retained at 180° C. for 1 hour (3600 seconds) under an air atmosphere in a constant temperature dryer (OF-450 manufactured by As One Co., Ltd.). The value of Y (=T×log₁₀(t)) is 640. In this way, a composite plated material subjected to heat treatment was obtained.

The producing conditions of the above composite material are summarized in Table 1 below, together with the producing conditions of Examples 2 to 8, which will be described later. In addition, the producing conditions of Comparative Examples 1 to 3 are summarized in Table 2 below.

The obtained composite material was evaluated as follows.

### ≤Thickness of the Composite Film>

When the thickness of the composite film of the composite material (circular range with a diameter of 0.2 mm at the center of the surface of 1.0 cm wide x 4.0 cm long) was measured using a fluorescent X-ray film thickness meter (FT9450 manufactured by Hitachi High-Tech Science Co., Ltd.), it was found to be 5.2 μm. With a fluorescent X-ray film thickness meter, it is difficult to detect C atoms (of carbon particles), and the thickness is obtained by detecting Ag atoms, and in the present invention, the thickness obtained thereby is regarded as the thickness of the composite film.

### <Amount of Ag, Amount of Sb, and Amount of C in the Composite Film>

The composite film was observed using a tabletop electron microscope (TM4000 Plus manufactured by Hitachi High-Technologies Corporation) under magnification of 1000× at an accelerating voltage of 15 kV, and in this observation area (1 field of view), EDX analysis was performed using an energy dispersive X-ray analyzer (AztecOne manufactured by Oxford Instruments Co., Ltd.) attached to the tabletop electron microscope. Then, only Ag and C elements were detected (Sb was not detected). Measured amounts of Ag (mass %), Sb (=0 mass %), and C (mass %) were defined as Ag content, Sb content, and carbon content in the composite film, respectively. As a result, the Ag content was 91.0% by mass, the Sb content was 0.0% by mass, and the carbon content was 9.0% by mass.

### <Crystallite Size of Silver in the Composite Film>

X-ray diffraction measurement (Cu Ku ray tube, tube voltage: 30 kV, tube current: 10 mA, step width: 0.01°, scanning range: 20=0° to 155°, scan speed: 5°/min, measurement time: approximately 31 minutes, (111) plane peak: 20=38.2 to 39.3°, (222) plane peak: 20=81.5 to 82.7°) was performed on the surface of the composite film using an X-ray diffraction device (D2Phaser 2nd Generation manufactured by Bruker Japan Co., Ltd.) in accordance with JISH7805:2005. From the detected peaks of (111) plane and (222) plane of silver, the full width at half maximum (FWHM) was obtained using X-ray analysis software (PDXL manufactured by Rigaku Co., Ltd.), and the crystallite size in each crystal plane of silver was calculated by Scherrer equation. In order to reduce the bias due to crystal planes, an average value of the crystallite sizes of the (111) plane and (222) plane of silver was defined as the crystallite size of silver. The crystallite size was found to be 58.0 nm.

The Scherrer's equation is as follows.

$$D = K \cdot λ / ( β \cdot cos θ )$$

D: Crystallite size
K: Scherrer constant, set to 0.9
λ: X-ray wavelength 1.54 Å because it is CuKα ray
J: Full width at half maximum (FWHM) (rad)
θ: Measurement angle (deg)

### <Carbon Area Ratio in the Surface of the Composite Film >

Backscattered electron composition (COMPO) image was obtained by observing the surface of a composite film using a tabletop microscope (TM4000 Plus manufactured by Hitachi High-Tech Corporation) under magnification of 1000× at an accelerating voltage of 5 kV, and this backscattered electron composition (COMPO) image was binarized using GIMP 2.10.10 (Image analysis software), to calculate an area ratio occupied by carbon in the surface of the composite film. Specifically, the area ratio occupied carbon was calculated as follows: a gradation is binarized so that pixels with a brightness of 127 or less are black and pixels with a brightness over 127 are white, with a highest brightness defined as 255 and a lowest brightness defined as 0 among all pixels, so as to be separated into a silver part (white part) and a carbon particle part (black part), and the ratio Y/X of the number Y of pixels in the carbon particle part to the number X of pixels in an entire image is defined as a carbon area ratio (%) in the surface. The carbon area ratio was found to be 21%.

### <Vickers Hardness Hv of the Composite Film Surface>

The Vickers hardness Hv of the surface of the composite film was measured according to JIS Z2244 using a microhardness meter (HM221 manufactured by Mitutoyo Co., Ltd.) by applying a load of 0.01 N to a flat part of the composite material for 15 seconds, and an average value of three measurements was adopted. As a result, the Vickers hardness was found to be 102.

### <Evaluation of Wear Resistance>

A flat specimen with a size of 2.0 cm in width x 3.0 cm in length was cut out from a plated material obtained by applying the same plating treatment (AgSb plating) as in Comparative Example 3 described later, to the same Cu—Ni—Sn—P alloy plate material used in Example 1.

On the other hand, a specimen with a size of 1.0 cm in width x 4.0 cm in length was cut out from the composite material obtained in the above Example 1, and this was indented (extruded into a hemispherical shape) with an inner diameter of 1.0 mm and an overhang height of 0.55 mm, to obtain an indented specimen (indenter).

Wear resistance was evaluated by performing an abrasion test using a sliding abrasion tester (CRS-G2050-DWA manufactured by Yamazaki Seiki Laboratory Co., Ltd.) as follows: reciprocating sliding operation was continued (sliding distance: 10 mm (that is, 20 mm in one reciprocation), sliding speed: 3 mm/s) while pressing the indented specimen against the above flat specimen with a constant load (2N) in such a manner that a convex portion of the indented specimen touches the flat specimen, to confirm a wear condition of the indented specimen. The result is as follows: after 2000 reciprocating sliding motions, the center of the sliding marks on the indented specimen was observed using a microscope (VHX-1000 manufactured by Keyence Corporation) under magnification of 200×. Then, it was confirmed that a (brown) substrate (alloy plate material) was not exposed, and it was found that the composite material of Example 1 had excellent wear resistance.

### <Evaluation of Bending Workability of the Composite Material>

The bending workability of the obtained composite material was evaluated as follows.

A specimen with a size of 1.0 cm in width x 4.0 cm in length was cut out from the obtained composite material, and indented (bended to extrude into hemispherical shape) to an inner diameter of 1.0 mm and an overhang height of 0.55 mm to produce an indented specimen. At this time, cracks may occur inside the plated film, and part or all of the film may easily fall off from the substrate.

For the above indented specimen, the thickness of the composite film at the vertex of the indentation was measured using a fluorescent X-ray film thickness meter in the same manner as described above, and then an adhesive tape (Cellotape (registered trademark) CT-18 (adhesive force: 4.02N/10 mm) manufactured by Nichiban Co., Ltd.) was applied to the vertex and then the adhesive tape was peeled off. After peeling off the adhesive tape, the thickness of the composite film at the vertex was again measured using a fluorescent X-ray film thickness meter, to obtain a reduction rate in the thickness of the composite film due to peeling of the composite film ((X−Y)/X×100%) from the thickness of the composite film before applying the adhesive tape (X) and the thickness of the composite film after peeling off the adhesive tape (Y).

As a result of the evaluation, the reduction rate in the thickness of the composite film was found to be 0%.

Basically, in all Examples and Comparative Examples (except Comparative Example 1), the thickness of the composite film at the vertex of the indent after indentation is slightly smaller than the thickness of the composite film on the composite material before indentation. The reason for this is considered as follows: the composite film was stretched and thinned by the bending treatment.

The above evaluation results are summarized in Table 3 below, together with the evaluation results of Examples 2 to 8, which will be described later. Further, the evaluation results of Comparative Examples 1 to 3 are summarized in Table 4 below.

### Example 2

The plating time for AgC plating was set to 1200 seconds. As a result, an AgC plated film with a thickness of 23.3 μm was formed. The value of Y (=T×log₁₀(t)) is 640. Other than that, the composite material was produced in the same manner as in Example 1.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 3 below.

### Example 3

The plating time for AgC plating was set to 1200 seconds. As a result, an AgC plated film with a thickness of 23.3 μm was formed. The temperature for the subsequent heat treatment was set to 1500 C, and the time for the heat treatment was set to 1 hour (3600 seconds). The value of Y (=T×log₁₀(t)) is 533. Other than that, the composite material was produced in the same manner as in Example 1.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated.

The evaluation results are summarized in Table 3 below.

### Example 4

The plating time for AgC plating was set to 1200 seconds. As a result, an AgC plated film with a thickness of 25.5 μm was formed. The temperature for the subsequent heat treatment was set to 150° C., and the time for the heat treatment was set to 30 minutes (1800 seconds). The value of Y (=T×log₁₀(t)) is 488. Other than that, the composite material was produced in the same manner as in Example 1.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 3 below.

### Example 5

The plating time for AgC plating was set to 300 seconds. As a result, an AgC plated film with a thickness of 5.4 μm was formed. The temperature for the subsequent heat treatment was set to 80° C., and the time for the heat treatment was set to 1 hour (3600 seconds). The value of Y (=T×log₁₀(t)) is 285. Other than that, the composite material was produced in the same manner as in Example 1.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 3 below.

### Example 6

Using the same substrate as in Example 1 as a cathode and the Ni electrode plate as an anode, electroplating (Ni plating) was performed for 45 seconds in a nickel plating bath (aqueous solution) composed of nickel sulfamate (Ni concentration: 80 g/L) and boric acid at a concentration of 45 g/L, while stirring at a liquid temperature of 55° C. and a current density of 6 A/dm², to form a Ni film (Ni base layer) with a thickness of 0.5 μm on the substrate. The thickness of the base layer was measured in the same manner as the method used to obtain the thickness of the composite film.

Ag strike plating was applied to the substrate on which the Ni base was formed and the plating time for AgC plating was set to 1200 seconds, to form an AgC plated film with a thickness of 17.6 μm, and the temperature for the subsequent heat treatment was set to 150° C. and the time for the heat treatment was set to 1 hour (3600 seconds). Other than that, the composite material was produced in the same manner as in Example 1. The value of Y (=T×log₁₀(t)) is 533.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 3 below.

### Example 7

The plating time for AgC plating was set to 1200 seconds. As a result, an AgC plated film with a thickness of 20.1 μm was formed. Subsequent ultrasonic cleaning was not performed, the temperature for the heat treatment was set to 150° C., and the time for the heat treatment was set to 1 hour (3600 seconds). The value of Y (=T×log₁₀(t)) is 533. Other than that, the composite material was produced in the same manner as in Example 1.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. Further, in the same manner as in Example 1, the amounts of Ag, Sb and C in the composite film were also measured. It was found that the Ag content was 58.9% by mass, the Sb content was 0.0% by mass, and the carbon content was 41.1% by mass. The evaluation results are summarized in Table 3 below.

### Example 8

The plating time for AgC plating was set to 300 seconds. As a result, an AgC plated film with a thickness of 5.3 μm was formed. The temperature for the subsequent heat treatment was set to 650° C., and the time for the heat treatment was set to 10 seconds. The value of Y (=T×log₁₀(t)) is 650. A muffle furnace (model number OF410 manufactured by Yamato Scientific Co., Ltd.) was used for the heat treatment. Other than that, the composite material was created in the same manner as in Example 1.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 3 below.

### Comparative Example 1

The composite material was produced in the same manner as in Example 2, except that the heat treatment in Example 2 was not performed.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 4 below.

In Comparative Example 1, there is a large difference between the thickness of the composite film and the thickness of the test area before the bending test, but this is considered as follows: part of the composite film fell off when the indentation was formed.

### Comparative Example 2

The composite material was produced in the same manner as in Example 1, except that the heat treatment of Example 1 was not performed and the carbon particle-containing sulfonic acid silver plating solution did not contain compound A.

For the obtained composite material, as in Example 1, the thickness of the composite film, the crystallite size of silver in the composite film, the carbon area ratio in the surface of the composite film, the Vickers hardness of the surface of the composite film, the wear resistance, and the bending workability, were evaluated. The evaluation results are summarized in Table 4 below.

### Comparative Example 3

### <Ag Strike Plating>

The same substrate as in Example 1 was prepared, and using this substrate as a cathode and a titanium-platinum mesh electrode plate (titanium mesh material plated with platinum) as an anode, electroplating (Ag strike plating) was performed at a current density of 5 A/dm² for 30 seconds in a cyan-based Ag strike plating solution at 25° C. containing a cyanide compound as a complexing agent (bath prepared from a general reagent, silver cyanide concentration: 3 g/L, potassium cyanide concentration: 90 g/L, solvent is water).

### <AgSb Plating>

A cyanide-based Ag—Sb alloy plating solution (solvent: water) containing a cyanide compound as a complexing agent and having a silver concentration of 60 g/L and an antimony (Sb) concentration of 2.5 g/L, was prepared. The cyanide-based Ag—Sb alloy plating solution contains 10% by mass of silver cyanide, 30% by mass of sodium cyanide, and Nissin Bright N (manufactured by Nissei Seiko Co., Ltd.). The concentration of Nissin Bright N in the plating solution is 50 mL/L, and Nissin Bright N contains a brightener and diantimony trioxide, and the concentration of the diantimony trioxide in Nissin Bright N is 6% by mass.

Next, using the above Ag strike plated substrate as a cathode and the silver electrode plate as an anode, electroplating was performed for 1000 seconds at a temperature of 18° C. and a current density of 3 A/dm² in the above cyan-based Ag—Sb alloy plating solution, while stirring at 400 rpm with a stirrer, to obtain a composite material in which a composite film (silver-antimony film) (plating thickness: 28.6 μm) was formed on the substrate.

For the obtained composite material, as in Example 1, the thickness of the composite film, the silver crystallite size of the composite film, the carbon area ratio in the surface of the composite film, the Vickers hardness of the surface of the composite film, the wear resistance, and the bending workability, were evaluated. Further, in the same manner as in Example 1, the amounts of Ag, Sb and C in the composite film were also measured. It was found that the Ag content was 98.0% by mass, the Sb content was 2.0% by mass, and the carbon content was 0.0% by mass. The evaluation results are summarized in Table 4 below.

TABLE 1

| | | | | Example 1 | | Example 2 | | Example 3 | | Example 4 | | Example 5 | |
|---|---|---|---|---|---|---|---|---|---|---|---|---|---|
| Base | Main | Nickel | | — | | — | | — | | — | | — | |
| layer | components | Complexing agent | | | | | | | | | | | |
| | of plating | (boric acid) | | | | | | | | | | | |
| | solution | | | | | | | | | | | | |
| | Current density | | | | | | | | | | | | |
| | Plating temperature | | | | | | | | | | | | |
| | Plating time | | | | | | | | | | | | |
| Strike | Main | Silver ion | | 3 | g/L | 3 | g/L | 3 | g/L | 3 | g/L | 3 | g/L |
| plating | components | Complexing | Methane- | 42 | g/L | 42 | g/L | 42 | g/L | 42 | g/L | 42 | g/L |
| | of plating | agent | sulfonic | | | | | | | | | | |
| | solution | | acid | | | | | | | | | | |
| | | | Others | — | | — | | — | | — | | — | |
| | Current density | | | 5 | A/dm² | 5 | A/dm² | 5 | A/dm² | 5 | A/dm² | 5 | A/dm² |
| | Plating temperature | | | 25° | C. | 25° | C. | 25° | C. | 25° | C. | 25° | C. |
| | Plating time | | | 90 | sec | 90 | sec | 90 | sec | 90 | sec | 90 | sec |
| Ag-based | Main | Silver ion | | 30 | g/l | 30 | g/l | 30 | g/l | 30 | g/l | 30 | g/l |
| plating | components | Compound A | | Present | | Present | | Present | | Present | | Present | |
| | of plating | Complexing | Methane- | 60 | g/L | 60 | g/L | 60 | g/L | 60 | g/L | 60 | g/L |
| | solution | agent | sulfonic | | | | | | | | | | |
| | | | acid | | | | | | | | | | |

| | | | | | |
|---|---|---|---|---|---|
| Others | — | — | — | — | — |

| | | | | | | | | | | |
|---|---|---|---|---|---|---|---|---|---|---|
| Carbon particle | 50 | g/L | 50 | g/L | 50 | g/L | 50 | g/L | 50 | g/L |
| concentration | | | | | | | | | | |

| | | | | | | | | | | | |
|---|---|---|---|---|---|---|---|---|---|---|---|
| | Current density | 3 | A/dm² | 3 | A/dm² | 3 | A/dm² | 3 | A/dm² | 3 | A/dm² |
| | Plating temperature | 25° | C. | 25° | C. | 25° | C. | 25° | C. | 25° | C. |
| | Plating time | 300 | sec | 1200 | sec | 1200 | sec | 1200 | sec | 300 | sec |
| Ultrasonic | Frequency | 28 | kHz | 28 | kHz | 28 | kHz | 28 | kHz | 28 | kHz |
| cleaning | Time | 240 | sec | 240 | sec | 240 | sec | 240 | sec | 240 | sec |
| Heat | Heat treatment temperature | 180° | C. | 180° | C. | 150° | C. | 150° | C. | 80° | C. |
| treatment | Heat treatment time | 3600 | sec | 3600 | sec | 3600 | sec | 1800 | sec | 3600 | sec |

| | | | | | |
|---|---|---|---|---|---|
| Value of T × log₁₀(t) | 640 | 640 | 533 | 488 | 285 |

| | | | | Example 6 | | Example 7 | | Example 8 | |
|---|---|---|---|---|---|---|---|---|---|
| Base | Main | Nickel | | 80 | g/L | — | | — | |
| layer | components | Complexing agent | | 45 | g/L | | | | |
| | of plating | (boric acid) | | | | | | | |
| | solution | | | | | | | | |
| | Current density | | | 6 | A/dm² | | | | |
| | Plating temperature | | | 55° | C. | | | | |
| | Plating time | | | 45 | sec | | | | |
| Strike | Main | Silver ion | | 3 | g/L | 3 | g/L | 3 | g/L |
| plating | components | Complexing | Methane- | 42 | g/L | 42 | g/L | 42 | g/L |
| | of plating | agent | sulfonic | | | | | | |
| | solution | | acid | | | | | | |

| | | | |
|---|---|---|---|
| Others | — | — | — |

| | Current density | | 5 | A/dm² | 5 | A/dm² | 5 | A/dm² |
|---|---|---|---|---|---|---|---|---|
| | Plating temperature | | 25° | C. | 25° | C. | 25° | C. |
| | Plating time | | 90 | sec | 90 | sec | 90 | sec |
| Ag-based | Main | Silver ion | 30 | g/l | 30 | g/l | 30 | g/l |

| | | | | | |
|---|---|---|---|---|---|
| plating | components | Compound A | Present | Present | Present |

| | | | | | | | | |
|---|---|---|---|---|---|---|---|---|
| of plating | Complexing | Methane- | 60 | g/L | 60 | g/L | 60 | g/L |
| solution | agent | sulfonic | | | | | | |
| | | acid | | | | | | |

| | | | |
|---|---|---|---|
| Others | — | — | — |

| | | | | | | |
|---|---|---|---|---|---|---|
| Carbon particle | 50 | g/L | 50 | g/L | 50 | g/L |
| concentration | | | | | | |

| | Current density | 3 | A/dm² | 3 | A/dm² | 3 | A/dm² |
|---|---|---|---|---|---|---|---|
| | Plating temperature | 25° | C. | 25° | C. | 25° | C. |
| | Plating time | 1200 | sec | 1200 | sec | 300 | sec |
| Ultrasonic | Frequency | 28 | kHz | — | | 28 | kHz |
| cleaning | Time | 240 | sec | — | | 240 | sec |
| Heat | Heat treatment temperature | 150° | C. | 150° | C. | 650° | C. |
| treatment | Heat treatment time | 3600 | sec | 3600 | sec | 10 | sec |

| | | | |
|---|---|---|---|
| Value of T × log₁₀(t) | 533 | 533 | 650 |

TABLE 2

| | | | | Comparative | | Comparative | | Comparative |
|---|---|---|---|---|---|---|---|---|
| | | | | Example 1 | | Example 2 | | Example 3 |
| Base layer | Main components | Nickel | | — | | — | | — |
| | of plating solution | Complexing agent (boric acid) | | | | | | |
| | Current density | | | | | | | |
| | Plating temperature | | | | | | | |
| | Plating time | | | | | | | |
| Strike | Main components | Silver ion | | 3 | g/L | 3 | g/L | AgCN(3 g/L) |
| plating | of plating solution | Complexing | Methanesulfonic acid | 42 | g/L | 42 | g/L | — |

| | | | | |
|---|---|---|---|---|
| agent | Others | — | — | KCN(90 g/L) |

| | Current density | | 5 | A/dm² | 5 | A/dm² | 5 | A/dm² |
|---|---|---|---|---|---|---|---|---|
| | Plating temperature | | 25° | C. | 25° | C. | 25° | C. |
| | Plating time | | 90 | sec | 90 | sec | 30 | sec |
| Ag-based | Main components | Silver ion | 30 | g/L | 30 | g/L | 60 | g/L |

| | | | | | |
|---|---|---|---|---|---|
| plating | of plating solution | Compound A | Present | None | None |

| | | | | | | |
|---|---|---|---|---|---|---|
| Complexing | Methanesulfonic acid | 60 | g/L | 60 | g/L | — |

| | | | | |
|---|---|---|---|---|
| agent | Others | — | — | NaCN |

| Other additives | — | | — | | *1 (Sb concentration: 2.5 g/L) |
|---|---|---|---|---|---|
| Carbon particle concentration | 50 | g/L | 50 | g/L | — |

| | | | | | | | |
|---|---|---|---|---|---|---|---|
| | Current density | 3 | A/dm² | 3 | A/dm² | 3 | A/dm² |
| | Plating temperature | 25° | C. | 25° | C. | 18° | C. |
| | Plating time | 1200 | sec | 300 | sec | 1000 | sec |
| Ultrasonic | Frequency | 28 | KHz | 28 | KHz | 28 | kHz |
| cleaning | Time | 240 | sec | 240 | sec | 240 | sec |

| | | | | |
|---|---|---|---|---|
| Heat | Heat treatment temperature | — | — | — |
| treatment | Heat treatment time | — | — | — |

*1: Nissin Bright N (glossy material) 50 mL/L. diantimony trioxide concentration in Nissin Bright N is 6% by mass

TABLE 3

| | | Example | | Example | | Example | | Example | | Example | | Example | | Example | | Example | |
|---|---|---|---|---|---|---|---|---|---|---|---|---|---|---|---|---|---|
| | | 1 | | 2 | | 3 | | 4 | | 5 | | 6 | | 7 | | 8 | |
| Base layer(Ni) | | None | | None | | None | | None | | None | | 0.5 | μm | None | | None | |
| Film | Composition | AgC | | AgC | | AgC | | AgC | | AgC | | AgC | | AgC | | AgC | |
| | Thickness of composite film(μm) | 5.2 | μm | 23.3 | μm | 23.3 | μm | 25.5 | μm | 5.4 | μm | 17.6 | μm | 20.1 | μm | 5.3 | μm |
| | Carbon area ratio in surface(%) | 21% | | 20% | | 24% | | 22% | | 17% | | 17% | | 79% | | 26% | |
| | Crystallite size(nm) | 58.0 | nm | 68.2 | nm | 58.2 | nm | 55.6 | nm | 44.4 | nm | 56.0 | nm | 58.1 | nm | 77.2 | nm |
| | Vickers hardness | 102 | | 99 | | 101 | | 109 | | 160 | | 100 | | 100 | | 93 | |
| Wear resistance | | None | | None | | None | | None | | None | | None | | None | | None | |
| (Base material exposure of indented specimen) | | | | | | | | | | | | | | | | | |
| Bending | Composite film thickness before | 4.7 | μm | 18.4 | μm | 17.6 | μm | 18.8 | μm | 4.1 | μm | 14.2 | μm | 15.7 | μm | 4.4 | μm |
| workability | test at test location | | | | | | | | | | | | | | | | |
| | Composite film thickness after | 4.7 | μm | 17.9 | μm | 17.5 | μm | 18.8 | μm | 3.9 | μm | 14.0 | μm | 15.7 | μm | 4.3 | μm |
| | test at test location | | | | | | | | | | | | | | | | |
| | Reduction in composite | 0 | μm | 0.5 | μm | 0.1 | μm | 0 | μm | 0.2 | μm | 0.2 | μm | 0 | μm | 0.1 | μm |
| | film thickness | | | | | | | | | | | | | | | | |

| | | | | | | | | |
|---|---|---|---|---|---|---|---|---|
| Reduction rate in composite | 0% | 3% | 1% | 0% | 5% | 1% | 0% | 2% |
| film thickness | | | | | | | | |

TABLE 4

| | | Com. | | Com. | | Com. | |
|---|---|---|---|---|---|---|---|
| | | Ex. 1 | | Ex. 2 | | Ex. 3 | |
| Base layer(Ni) | | None | | None | | None | |
| Film | Composition | AgC | | AgC | | AgSb | |
| | Thickness of composite film(μm) | 22.8 | μm | 5.9 | μm | 28.6 | μm |
| | Carbon area ratio in surface(%) | 18% | | 30% | | — | |
| | Crystallite size(nm) | 21.1 | nm | 78.8 | nm | 11.9 | nm |
| | Vickers hardness | 162 | | 70 | | 180 | |
| Wear resistance | | None | | Yes | | Yes | |
| (Base material exposure of indented specimen) | | | | (100 times) | | (1400 | times) |
| Bending | Composite film thickness before test at test location | 12.0 | μm | 5.5 | μm | 27.1 | μm |
| workability | Composite film thickness after test at test location | 4.6 | μm | 5.5 | μm | 26.6 | μm |
| | Reduction in composite film thickness | 7.4 | μm | 0 | μm | 0.5 | μm |

| | | | |
|---|---|---|---|
| Reduction rate in composite film thickness | 62% | 0% | 2% |

*Com. Ex. = Comparative Example

Table 3 shows that in each Example, the composite material with excellent wear resistance and bending workability was realized.

Table 4 shows that in the evaluation of the wear resistance, in Comparative Examples 2 and 3, the composite film on the convex portion of the indented specimen was peeled off, thereby exposing the material. More specifically, in Comparative Example 2, when the test was stopped once at the stage of 100 sliding cycles to observe the center of the sliding marks on the indented specimen in the same manner as in Example 1, it was confirmed that a (brown) substrate (alloy plate material) was exposed. Further, in Comparative Example 3, when the test was stopped once at the stage of 1400 sliding cycles to observe the center of the sliding marks on the indented specimen in the same manner as in Example 1, it was confirmed that a (brown) substrate (alloy plate material) was exposed.

Regarding the composite material of Comparative Example 2, it is considered that wear occurred due to low Vickers hardness Hv of the composite film.

The composite film of the composite material according to Comparative Example 1 had high Vickers hardness Hv and excellent wear resistance, Although this is an example of using the carbon particle-containing sulfonic acid silver plating solution including compound A according to Comparative Example 2. However, in evaluation of bending workability, most of the composite film was peeled off due to peeling of the adhesive tape, and it was found that bending workability was poor.

Regarding Comparative Example 3 resulting in insufficient wear resistance, adhesive wear is considered to be the mode of wear, but in each example, it is considered that the adhesion of silver was suppressed by carbon particles in the composite film of the composite material, and meanwhile, in Comparative Example 3, silver adhesion occurred, leading to wear.

1. A composite material having a composite film on a substrate, the composite film including a silver layer that contains carbon particles, wherein a crystallite size of silver of the composite film is 30 to 100 nm and Vickers hardness Hv of the composite film is 75 or more.

2. The composite material according to claim 1, wherein a proportion of the carbon particles in a surface of the composite film is 1 to 80% by area.

3. The composite material according to claim 1, wherein the composite film has a thickness of 0.5 to 45 μm.

4. The composite material according to claim 1, wherein the composite film has a carbon content of 1 to 50% by mass.

5. The composite material according to claim 1, wherein the substrate is composed of Cu or a Cu alloy.

6. A method for producing a composite material, the method including:
performing electroplating in a silver plating solution containing carbon particles to form a composite film on a substrate, the composite film including a silver layer that contains carbon particles; then,
applying heat treatment to the composite film,
wherein the silver plating solution contains a compound A represented by the following general formula (I), and
after forming the composite film on the substrate, the heat treatment is applied to the composite film to increase a crystallite size of silver of the composite film: 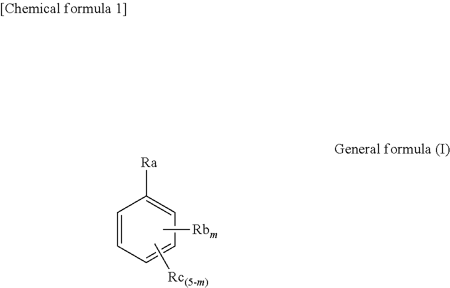
(In formula (I), m is an integer from 1 to 5,
Ra is a carboxyl group,
Rb is an aldehyde group, carboxyl group, amino group, hydroxyl group or sulfonic acid group,
Rc is hydrogen or is an arbitrary substituent,
when m is 2 or more, multiple Rb's may be the same or different from each other,
when m is 3 or less, multiple Rc's may be the same or different from each other, and
Ra and Rb may each be independently bonded to a benzene ring through a divalent group composed of at least one selected from a group consisting of —O— and —CH₂—).

7. The method for producing a composite material according to claim 6, wherein 80≤T≤750, 3≤t≤86400, 240≤Y≤1000 are established, in which heating temperature during the heat treatment is T (° C.), heating time during the heat treatment is t (seconds), and Y=T×log₁₀(t).

8. The method for producing a composite material according to claim 6, wherein the silver plating solution does not substantially contain a cyanide compound.

9. The method for producing a composite material according to claim 6, wherein the silver plating solution contains a compound having a sulfonic acid group.

10. The method for producing a composite material according to claim 6, wherein the substrate is composed of copper (Cu) or a Cu alloy.

11. The method for producing a composite material according to claim 6, wherein the carbon particles are graphite particles whose volume-based cumulative 50% particle diameter (D50) is 0.5 to 15 μm as measured by a laser diffraction/scattering particle size distribution analyzer.

12. A terminal in which the composite material according to claim 1 is used as its constituent material.
